(19) United States
(12) Patent Application Publication
(10) Pub. No.: US 2009/0273116 A1
(43) Pub. Date: Nov. 5, 2009

(54) SLUSH MOLDABLE OLEFIN COMPOSITION

(75) Inventors: William McHugh Humphrey, Jr., Dover, NH (US); Paul Joseph Drago, Rochester, NH (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: International Automotive Components Group North America, Inc., Dearborn, MI (US)

(21) Appl. No.: 12/113,146

(22) Filed: Apr. 30, 2008

(51) Int. Cl. B29D 7/01; C08L 23/06; C08K 5/541; C08L 23/16

(52) U.S. Cl. 264/216; 525/240; 524/265; 524/528

(57) ABSTRACT

A slush moldable composition includes a low density polyethylene resin, propylene-ethylene copolymer, olefin block copolymer, a thermoplastic olefin and silicon oil combination, and an optional pigment. A method for forming a instrument panel skin from the slush moldable composition is provided.

### BACKGROUND OF THE INVENTION

1. Field of the Invention

The present invention relates to resins that are useful for making instrument panel skins used in automobile interiors.

2. Background Art

Currently, three manufacturing processes dominate the vehicle instrument panel manufacturing arena. The dominant processes are slush molding, vacuum forming, and spray urethane. Although each process works reasonably well, there are associated issues.

Vacuum formed instrument panels have a hard “hand” and do not perform cleanly (no shredding or sharding) during −30° C. airbag deployment at −30° C. Moreover, long term weathering has shown that these products become brittle. Spray urethane (aliphatic with inherent light stability and aromatic where a coating is required for weatherability) have less desirable “hand.” Although the spray urethane exhibits property retention after aging and weathering, these materials also exhibit shredding and sharding during −30° seamless airbag deployment. Slush molding can utilize PVC and TPU elastomers. Although certain modified PVCs have acceptable unpainted “hand” for instrument panels, the same materials tend to exhibit the same shredding and sharding issues during −30° C. seamless airbag deployments.

Monomers derived from cracked hydrocarbon sources (e.g. ethylene, propylene, butane etc) are used to form a number of polymer resins. For example, these monomers have been used for decades to produce HDPE, LLDPE, LDPE, and PP resins. However, such resins are generally not used in slush molding applications.

Accordingly, there is a need for new material for forming vehicle instrument panels having acceptable aesthetic touch properties while exhibiting proper function during low temperature airbag deployment.

### SUMMARY OF THE INVENTION

The present invention solves one or more problems of the prior art by providing in at least one embodiment a polyolefin-based slush moldable composition. The slush moldable composition includes a low density polyethylene resin, a propylene-ethylene copolymer, olefin block copolymer, a thermoplastic olefin and silicon oil combination, and an optionally pigment.

In another embodiment, a method for forming an instrument panel skin is provided. The method of this embodiment includes a step of introducing the polyolefin-based slush moldable composition into a mold tool. Typically, these compositions are in the form of a powder. The polyolefin-based slush moldable composition is heated to a sufficient temperature to form a layer over at least a portion of the mold tool. Excess powder is poured from the mold tool and heating continued if necessary. The instrument panel skin is removed from the mold tool.

### BRIEF DESCRIPTION OF THE DRAWINGS

FIGS. 1A and 1B area pictorial flowchart depicting an embodiment for forming an instrument panel skin; and

FIG. 2 is a pictorial flowchart depicting the application of a support structure to an instrument panel skin.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

In an embodiment of the present invention, a polyolefin-based slush moldable composition is provided. The composition of this embodiment includes a low density polyethylene resin having a density less than about 0.95 g/cm³. In a refinement, the low density polyethylene resin has a density less than about 0.93 g/cm³. In another refinement, the low density polyethylene resin has a density from about 0.90 g/cm³ to about 0.95 g/cm³. Densities are determined in accordance to ASTM D 4883. In still another refinement, the polyethylene resin has a melt flow index from about 100 g/10 min to about 250 g/10 min (190° C., 2.116 Kg). These melt flow indexes are determined in accordance with ASTM D 1238. Suitable polyolefins include, but are not limited to, EC812, commercially available from Westlake Chemical located in Longview Tex. EC 812 in particular has a very high melt flow index (200 g/10 min, 190° C./2.116 Kg (ASTM D 1238), density of 0.909 per ASTM D 4883 and a brittleness temperature of <−28° C. (ASTM D 1525). In a variation of the present embodiment, the polyethylene resin is present in an amount from about 60% to about 99% of the total weight of the polyolefin-based slush moldable composition. In another variation of the present embodiment, the polyethylene resin is present in an amount from about 70% to about 90% of the total weight of the polyolefin-based slush moldable composition. In another variation of the present embodiment, the polyethylene resin is present in an amount from about 75% to about 80% of the total weight of the polyolefin-based slush moldable composition.

The polyolefin-based slush moldable composition further includes a propylene-ethylene copolymer. The propylene-ethylene copolymer used in the present embodiment is characterized by a number of physical characteristics. In a refinement, the propylene-ethylene copolymer has a total crystallinity less than about 20%. In another refinement, the propylene-ethylene copolymer has a flexural modulus (1% secant) from about 1500 psi to about 2500 psi and a Shore A hardness from about 40 to about 80 (ISO 898 ASTM D2240). Examples of useful propylene-ethylene copolymers include, but are not limited to the Versify™ line or elastomers commercially available from The Dow Chemical Company. Versify™ 2400 is found to be particularly useful. Versify™ 2400 has a narrow molecular weight distribution and broad crystallinity distribution, a melt flow rate of 2 g/10 min (230° C./2.16 Kg per ASTM D 1238), a glass transition temperature of −33° C., a total crystallinity of 7% and a 68 Shore A Hardness (ASTM D 2240). Typically, the propylene-ethylene copolymer is present in an amount from about 1 to 25 weight percent of the polyolefin-based slush moldable composition. In another refinement, the propylene-ethylene copolymer is present in an amount from about 5 to 20 weight percent of the polyolefin-based slush moldable composition. In still another refinement, the propylene-ethylene copolymer is present in an amount of about 20% weight percent of the polyolefin-based slush moldable composition.

In a variation of the present invention, the polyolefin composition further includes a thermoplastic vulcanizate. Such thermoplastic vulcanizates are thermoplastic elastomers. Typically such thermoplastic vulcanizates are non-hydroscopic. Suitable example of such thermoplastic vulcanizates include, but are not limited to, Santoprene 8211-55B100 commercially available from ExxonMobil located in Akron Ohio. This material has a brittle temperature of −44° C. (ASTM D 746), a Shore A Hardness of 58 (ASTM D 2240), and a density of 1.04. Typically, the thermoplastic vulcanizate is present in an amount from about 1 to 25 weight percent of the polyolefin-based slush moldable composition. In another refinement, the thermoplastic vulcanizate is present in an amount from about 5 to 20 weight percent of polyolefin-based slush moldable composition. In still another refinement, the thermoplastic vulcanizate is present in an amount of about 20% weight percent of the polyolefin-based slush moldable composition.

In another variation, the polyolefin-based composition further includes an olefin block copolymer having alternating blocks of hard and soft segments. An example of a useful olefin block copolymer is Infuse D9000.00 from Dow Chemical (Midland Mich.), which is described as a high performance olefin block copolymer with alternating blocks of hard and soft segments. Melting and crystallization temperatures of these olefinic block coploymers are up to 50° C. higher that results in higher heat resistance and faster set-up times. Infuse D9000.00 has a reported melt flow index of 0.5 g/min (190° C./2.16 Kg) per ASTM D 1238; a density of 0.877 and 75 Shore A Hardness per ASTM D 2240. Typically, the olefin block copolymer is present in an amount from about 1 to 25 weight percent of the polyolefin-based slush moldable composition. In another refinement, the olefin block copolymer is present in an amount from about 5 to 20 weight percent of polyolefin-based slush moldable composition. In still another refinement, the olefin block copolymer is present in an amount of about 20% weight percent of the polyolefin-based slush moldable composition.

In yet another variation of the present embodiment, the polyolefin-based composition further includes a thermoplastic olefin and silicon oil combination. Suitable examples of such olefin/silicon oil combinations include, but are not limited to, PRI 3116 from American Commodities Incorporated located in Flint Mich. It is described as a 34 Shore A clear thermoplastic olefin with silicone oil with a density of 0.8914 per ASTM D 792. Typically, the thermoplastic olefin and silicon oil combination is present in an amount from about 1 to 25 weight percent of the polyolefin-based slush moldable composition. In another refinement, the thermoplastic olefin and silicon oil combination is present in an amount from about 5 to 20 weight percent of polyolefin-based slush moldable composition. In still another refinement, the thermoplastic olefin and silicon oil combination is present in an amount of about 20% weight percent of the polyolefin-based slush moldable composition.

In still another variation of the present invention, the polyolefin composition includes at least one pigment. Suitable examples of pigments include, but are not limited to, Clariant 2N4A Medium Dark which is a color concentrate in UF-0205 TPU that contains enough Irganox 1135 (Ciba-Geigy) and Irganox 5057 (Ciba-Geigy) to provide 0.50% and 0.12% by weight in the final elastomer at 2% by weight pigment solids in the final elastomer. In a refinement, the pigments are present in an amount from about 0.2 to about 10 weight percent of the polyolefin-based slush moldable composition.

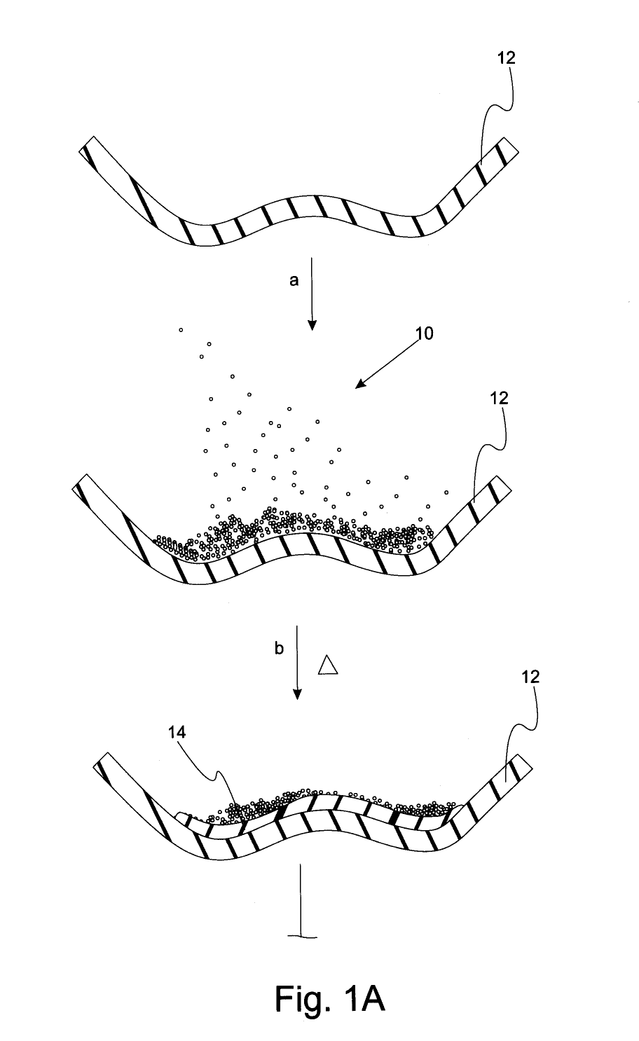

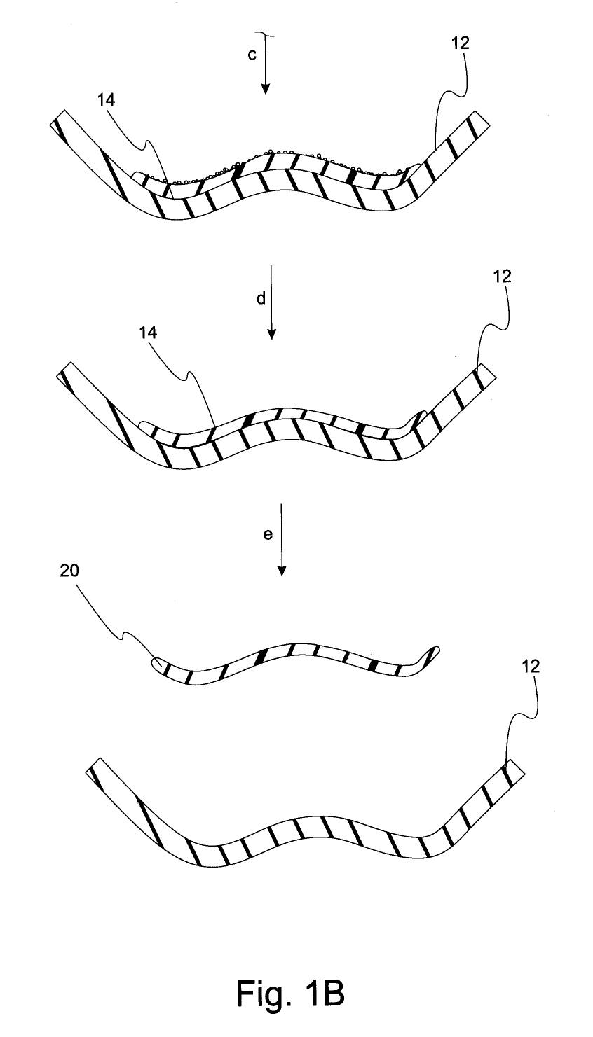

With reference to FIGS. 1A and 1B, a pictorial flowchart depicting a slush molding method for forming an instrument panel skin is provided. The method of this embodiment comprises introducing polyolefin-based slush moldable composition 10 into mold tool 12. At least a portion of mold tool 12 is made from a metal such as stainless steel or nickel. Polyolefin-based slush moldable composition 10 includes the compositions set forth above.

In a subsequent step b), polyolefin-based slush moldable composition 10 is heated to a sufficient temperature to form layer 14 over at least a portion of mold tool 12. In one refinement, urethane based resin composition 10 is heated to a temperature between about 170° C. and 250° C. In step c), powder is poured out from mold tool 12. Mold is further heated if necessary so that all the powder melts. Finally, instrument panel skin 20 is removed from mold tool 12 is step e). Typically, instrument panel skin 20 has a thickness from about 0.5 mm to about 2 mm.

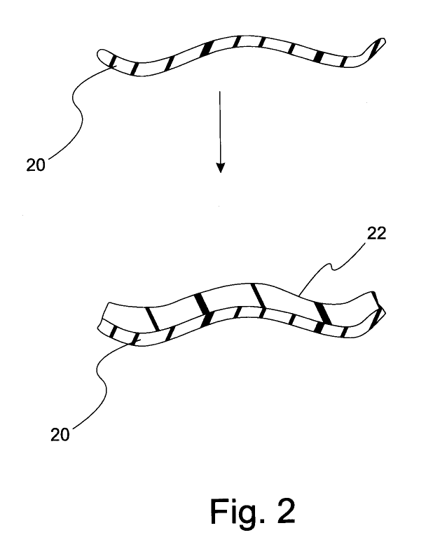

With reference to FIG. 2, a flowchart showing the application of a backing to instrument panel skin 20 is provided. In step f), structural component 22 is applied to instrument panel skin 20. Such structural components are applied by any number of methods known to those skilled in the art. In one refinement, structural component 22 has a thickness from about 2 mm to about 20 mm. In some variations, foam resins such as Dow Specflex NM815 are utilized. In one variation, skin 22 may be placed in a mold that provides a predetermined shape and a urethane backing sprayed over the back of instrument panel skin 20. In another variation, structural component 22 can be molded onto instrument panel skin 20. In such circumstances thermoplastic resins may be used.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A polyolefin-based composition for slush molding applications, the polyolefin-based composition comprising:
a low density polyethylene resin; and
a propylene-ethylene copolymer.

2. The polyolefin-based composition of claim 1 further comprising an olefin block copolymer.

3. The polyolefin-based composition of claim 1 wherein the olefin block copolymer is present in an amount from about 1 to about 25% of the total weight of the polyolefin-based composition.

4. The polyolefin-based composition of claim 1 further comprising a thermoplastic olefin and silicon oil combination.

5. The polyolefin-based composition of claim 1 wherein the thermoplastic olefin and silicon oil combination is present in an amount from about 1 to about 25% of the total weight of the polyolefin-based composition.

6. The polyolefin-based composition of claim 1 further comprising a pigment.

7. The polyolefin-based composition of claim 1 wherein the thermoplastic olefin and silicon oil combination is present in an amount from about 60 to about 99% of the total weight of the polyolefin-based composition.

8. The polyolefin-based composition of claim 1 wherein the thermoplastic olefin and silicon oil combination low density polyethylene resin is present in an amount from about 70 to about 90% of the total weight of the polyolefin-based composition.

9. The polyolefin-based composition of claim 1 wherein the propylene-ethylene copolymer is present in an amount from about 1 to about 25% of the total weight of the polyolefin-based composition.

10. The polyolefin-based composition of claim 1 wherein the low density polyethylene resin has a density less than 0.95 g/ml.

11. A polyolefin-based composition for slush molding applications, the polyolefin-based composition comprising:
low density polyethylene resin;
propylene-ethylene copolymer;
an olefin block copolymer; and
a thermoplastic olefin and silicon oil combination.

12. The polyolefin-based composition of claim 11 wherein the olefin block copolymer is present in an amount from about 1 to about 25% of the total weight of the polyolefin-based composition.

13. The polyolefin-based composition of claim 11 wherein the thermoplastic olefin and silicon oil combination is present in an amount from about 1 to about 25% of the total weight of the polyolefin-based composition.

14. The polyolefin-based composition of claim 11 wherein the thermoplastic olefin and silicon oil combination is present in an amount from about 60 to about 99% of the total weight of the polyolefin-based composition.

15. The polyolefin-based composition of claim 11 wherein the thermoplastic olefin and silicon oil combination low density polyethylene resin is present in an amount from about 70 to about 90% of the total weight of the polyolefin-based composition.

16. The polyolefin-based composition of claim 11 wherein the propylene-ethylene copolymer is present in an amount from about 1 to about 25% of the total weight of the polyolefin-based composition.

17. The polyolefin-based composition of claim 11 wherein the low density polyethylene resin has a density less than 0.95 g/ml.

18. A method of forming a instrument panel skin, the method comprising:
a) introducing a polyolefin-based composition comprising:
low density polyethylene resin; and
a propylene-ethylene copolymer;
b) heating the polyolefin-based composition to a sufficient temperature to form a layer over at least a portion of the mold tool;
c) pouring out powder from the mold tool;
d) optionally continuing to heat the mold tool so that all the powder melts; and
e) removing the instrument panel skin from the mold tool.

19. The method of claim 17 further comprising:
f) applying the instrument panel skin to a structural component.

20. The method 17 wherein the polyolefin-based composition further comprises an olefin block copolymer and a thermoplastic olefin and silicon oil combination.
